(19) United States
(12) Patent Application Publication
(10) Pub. No.: US 2018/0320704 A1
(43) Pub. Date: Nov. 8, 2018

(54) REMOVABLE INTEGRATED WEAR RING IMPELLER SKIRT

(71) Applicant: Fluid Handling LLC, Morton Grove, IL (US)

(72) Inventors: Christopher Stephen JOHNSON, Gurnee, IL (US); Marcos Daniel ROIMICHER, Lombard, IL (US); Patrycja Delcourt, Mount Prospect, IL (US)

(21) Appl. No.: 15/968,196

(22) Filed: May 1, 2018

Related U.S. Application Data
(60) Provisional application No. 62/492,602, filed on May 1, 2017.

(51) Int. Cl. F04D 29/22; F04D 1/00; F04D 29/16; F04D 29/42; F04D 29/60

(52) U.S. Cl. CPC F04D 29/2294; F04D 1/006; F04D 29/607; F04D 29/4273; F04D 29/167

(57) ABSTRACT

A double suction impeller features an impeller main body and an impeller suction eye. The impeller main body may include a suction eye adapter coupling member. The impeller suction eye may include a removable suction eye adapter having a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece.

### CROSS-REFERENCE TO RELATED APPLICATION

This application claims benefit to provisional patent application Ser. No. 62/492,602, filed 1 May 2017, which is hereby incorporated by reference in its entirety.

### BACKGROUND OF THE INVENTION

### 1. Field of the Invention

The present invention relates to a pump; and more particularly to a centrifugal pump having an impeller wear ring.

### 2. Brief Description of Related Art

Within centrifugal pumps, in order to allow the impeller to rotate freely within the pump casing, a small clearance is designed to be maintained between the rotating impeller and the stationary pump casing. It is necessary to minimize the amount of leaking through this clearance (from high-pressure or discharge side of the pump back to the low-pressure or suction side) in order to maximize the efficiency of the centrifugal pump. Wear and erosion occur at the point of near-contact between the impeller and the pump casing due to liquid leaking through this tight clearance and other causes. As wear occurs, the leakage could become unacceptably large and maintenance would be required on the pump. To minimize the cost of maintenance, many centrifugal pumps are designed with wear rings. These rings are replaceable parts attached to the impeller and/or the pump casing and are designed to be replaced periodically during the life of the pump and prevent more costly part replacements (i.e. impellers and/or casings). They allow a small running clearance between the impeller and the pump casing without causing wear of the actual impeller or casing.

Some of the shortcomings of the above mentioned devices include the following:

Many markets require specific wear ring configurations. While some may not require any wear rings at all, others may want to include both a wear ring on the casing and on the impeller. In order to account for this, there must be provisions made to the amount of material and space available for the different configurations. The additional material in the casing and the impeller pose manufacturing and marketing issues (i.e. possible pouring issues, increased weight, increased manufacturing cost etc.).

Another common problem with wear rings is galling. Galling happens whenever two metals are in close running clearance and get a burr either due to abrasives in the pumped fluid or rubbing. This causes a localized hot spot that welds the two pieces together.

By way of example, the reader is referred to U.S. Pat. No. 4,563,124, which discloses a double suction, single stage, volute pump having an impeller with opposed inlet eyes and also with opposed external cylindrical portions adapted to be received with wear rings, which is similar to that shown in FIG. 1 herein. The wear rings are arranged between impeller shrouds and the opposed external cylindrical portions, which form an integral part of the impeller and are not removable or detachable from the main body of the impeller, which is also similar to that shown in FIG. 1. U.S. Pat. No. 4,563,124 is hereby incorporated by reference in its entirety.

### SUMMARY OF THE INVENTION

In summary, the goal of the present invention is to remove impeller wear rings and instead replace them with a removable component of the impeller itself. When an impeller wear ring is used it rests on the outer diameter of the impeller suction eye. Instead, the proposition disclosed herein is to alter the impeller so that the suction eye can be removed and replaced when wear and erosion occurs. The suction eye of the impeller would then become a separate cast and/or machined piece. This would reduce the weight of the impeller casting itself, and reduce the manufacturing costs.

### Specific Embodiments

According to some embodiments, the present invention may take the form of a double suction impeller featuring an impeller main body and an impeller suction eye.

The impeller main body may include a suction eye adapter coupling member.

The impeller suction eye may include a removable suction eye adapter having a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece.

The present invention may include one or more of the following features:

The double suction impeller may include a set screw having a threaded end; the suction eye adapter coupling member may include a threaded opening configured to receive the threaded end of the set screw; and the corresponding removable suction eye adapter may include a corresponding opening configured to allow the set screw to pass through and the threaded end to be received by the threaded opening of the suction eye adapter coupling member to couple the removable suction eye adapter to the impeller main body. In this embodiment, the set screw may be configured parallel to the flow of the pump medium, which is understood to flow into the suction eyes of the double suction impeller.

The suction eye adapter coupling member and the corresponding suction eye adapter coupling member may include mated threaded faces configured to provide a fully threaded attachment between the impeller main body and the removable suction eye adapter.

The double suction impeller may include a set screw having a threaded end; the corresponding suction eye adapter coupling member may include a threaded opening configured to receive the threaded end of the set screw; and the suction eye adapter coupling member may include a corresponding opening configured to allow the set screw to pass through and the threaded end to be received by the threaded opening of the corresponding suction eye adapter coupling member to couple the removable suction eye adapter to the impeller main body. In this embodiment, the set screw may be configured normal to the flow of the pump medium.

The impeller main body may include a second suction eye adapter coupling member; and the double suction impeller may include a second impeller suction eye having a second removable suction eye adapter with a second corresponding suction eye adapter coupling member configured to couple detachably to the second suction eye adapter coupling member of the impeller main body, whereby the second removable suction eye adapter can be removed and replaced when wear and erosion occurs and can be a second separate cast and/or machined piece.

The double suction impeller may include a second set screw having a corresponding threaded end; the second suction eye adapter coupling member may include a second threaded opening configured to receive the corresponding threaded end of the second set screw; and the second corresponding suction eye adapter coupling member may include a second corresponding opening configured to allow the second set screw to pass through and the corresponding threaded end to be received by the second threaded opening of the suction eye adapter coupling member to couple the second removable suction eye adapter to the impeller main body. In this embodiment, the second set screw may be configured parallel to the flow of the pump medium.

The second suction eye adapter coupling member and the second corresponding suction eye adapter coupling member may include second mated threaded faces configured to provide a second fully threaded attachment between the impeller main body and the second removable suction eye adapter.

The double suction impeller may include a second set screw having a corresponding threaded end; the second corresponding suction eye adapter coupling member may include a second threaded opening configured to receive the corresponding threaded end of the second set screw; and the second suction eye adapter coupling member may include a second corresponding opening configured to allow the second set screw to pass through and the corresponding threaded end to be received by the second threaded opening of the second corresponding suction eye adapter coupling member to couple the second removable suction eye adapter to the impeller main body. In this embodiment, the second set screw may be configured normal to the flow of the pump medium.

The double suction impeller may include a gasket arranged between the suction eye adapter coupling member and the corresponding suction eye adapter coupling member and configured to prevent leakage. The double suction impeller may also include a second gasket arranged between the second suction eye adapter coupling member and the second corresponding suction eye adapter coupling member and configured to prevent leakage.

The double suction impeller may include an O-ring arranged between the suction eye adapter coupling member and the corresponding suction eye adapter coupling member and configured to prevent leakage. The double suction impeller may also include a second O-ring arranged between the second suction eye adapter coupling member and the second corresponding suction eye adapter coupling member and configured to prevent leakage.

The removable suction eye adapter and the second removable suction eye adapter may be configured as symmetrical and interchangeable removable suction eye adapters.

The present invention may also take the form of a pump featuring a double suction impeller having an impeller main body and one or more impeller suction eyes, according to the present invention. For example, the impeller main body may include a suction eye adapter coupling member. The one or more impeller suction eyes may include a removable suction eye adapter having a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece. According to some embodiments, the pump may be a centrifugal pump.

The present invention may also take the form of a suction impeller featuring an impeller main body and an impeller suction eye, according to the present invention. The impeller main body may include a suction eye adapter coupling member. The impeller suction eye may include a removable suction eye adapter having a corresponding suction eye adapter coupling member configured to couple detachably to the suction eye adapter coupling member of the impeller main body, whereby that the removable suction eye adapter can be removed and replaced when wear and erosion occurs and can be a separate cast and/or machined piece. According to some embodiments, and consistent with that disclosed herein, the suction impeller may be a double suction impeller.

In effect, and according to some embodiments of the present invention, the one or more removable and replaceable suction eye adapters may take the form of one or more removable integrated wear ring impeller skirts, e.g., consistent with that disclosed herein.

### BRIEF DESCRIPTION OF THE DRAWING

The drawing, which is not necessarily drawn to scale, includes the following Figures:

FIG. 1 shows a conventional impeller wear ring design that is known in the art. In the conventional double suction impeller with impeller wear rings as shown, the impeller wear rings are retained on the outer diameter of the suction eye of the impeller with a shrink fit. In FIG. 1, the suction eye of the impeller is not removable on either side of the impeller main body.

FIG. 2 shows a removable integrated wear ring impeller skirt, according to some embodiments of the present invention, e.g., where the impeller suction eyes become removable integrated wear rings which become replaceable parts for the purposes of maintenance.

FIG. 3 shows a parallel set screw attachment, according to some embodiments of the present invention, e.g., where the removable integrated wear ring impeller skirt is retained to the main body of the impeller using set screws (or other type of bolts) which is parallel to the flow of pumped medium. As shown, a flat gasket is used to prevent leakage.

FIG. 4 shows a fully threaded attachment, according to some embodiments of the present invention.

FIG. 5 shows a normal set screw attachment, according to some embodiments of the present invention, e.g., where the removable integrated wear ring impeller skirt is retained to the main body of the impeller using set screws (or other type of bolts) which is normal to the flow of pumped medium, and an O-Ring is used to prevent leakage.

FIG. 6 shows an example of a double suction single stage pump having a conventional impeller wear ring design that is known in the art, which is known in the art.

FIG. 7 shows an example of a single suction impeller design, which is known in the art.

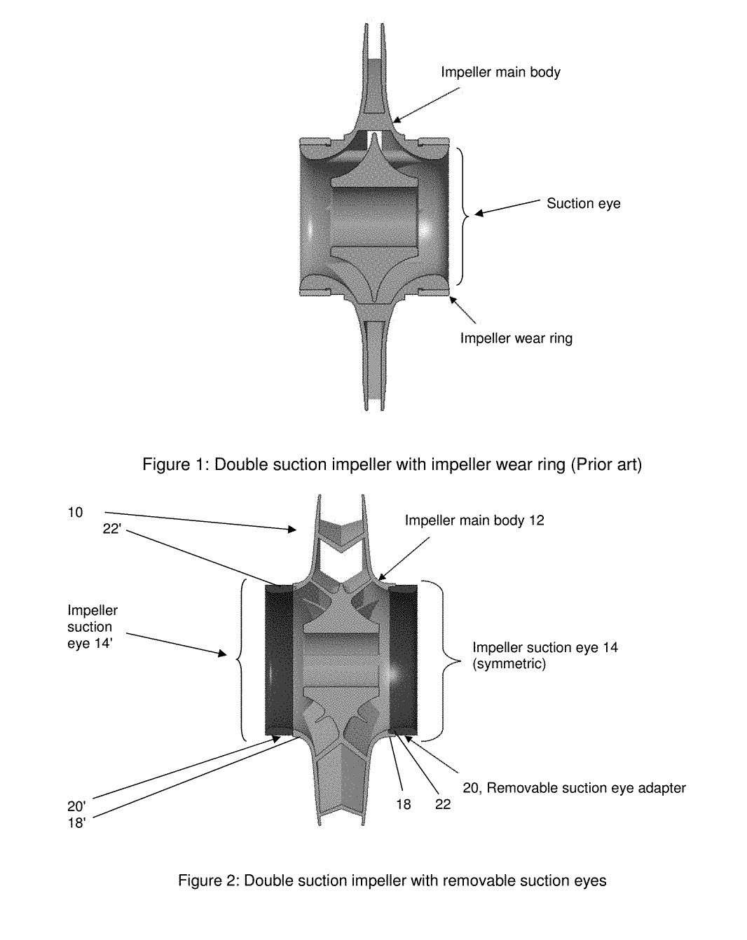

Similar parts or components in the Figures are labeled with similar reference numerals and labels for consistency. Every lead line and associated reference label for every element is not included in every Figure of the drawing to reduce clutter in the drawing as a whole.

### DETAILED DESCRIPTION OF THE INVENTION

### FIG. 2

FIG. 2 shows a double suction impeller generally indicated as 10 featuring an impeller main body 12 and one or more impeller suction eyes generally indicated as 14, 14′.

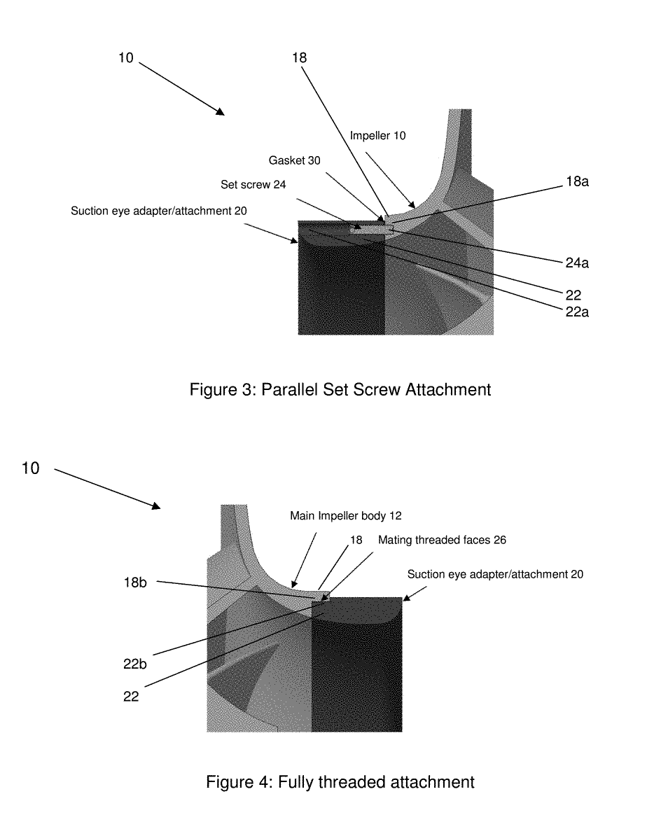

The impeller main body 12 may include a suction eye adapter coupling member 18. By way of an example, the suction eye adapter coupling member 18 may include a threaded opening to receive a set screw, a threaded mating face or a non-threaded opening to allow a set screw to pass through, consistent with that disclosed herein in relation to FIGS. 3-5.

The one or more impeller suction eyes may include an impeller suction eye 14 having a removable suction eye adapter 20 with a corresponding suction eye adapter coupling member 22 configured to couple detachably to the suction eye adapter coupling member 18 of the impeller main body 12, whereby the removable suction eye adapter 20 can be removed and replaced when wear and erosion occurs and can be a separate cast and/or machined piece. By way of an example, and similar to the suction eye adapter coupling member 18, the corresponding suction eye adapter coupling member 22 may include a threaded opening to receive a set screw, a threaded mating face or a non-threaded opening to allow a set screw to pass through, consistent with that disclosed herein in relation to FIGS. 3-5.

### FIG. 3: Parallel Set Screw Attachment

By way of example, FIG. 3 shows one detachable coupling implementation between the suction eye adapter coupling member 18 and the corresponding suction eye adapter coupling member 22, e.g., using a parallel set screw attachment.

In FIG. 3, the double suction impeller 10 may include a set screw 24 having a threaded end 24a. The suction eye adapter coupling member 18 may include a threaded opening 18a configured to receive the threaded end 24a of the set screw 24; and the corresponding removable suction eye adapter 22 may include a corresponding opening 22a configured to allow the set screw 24 to pass through and the threaded end 24a to be received by the threaded opening 18a of the suction eye adapter coupling member 18 to couple the removable suction eye adapter 14 to the impeller main body 12. In this embodiment, the set screw 24 may be configured parallel to the flow of the pump medium.

### FIG. 4: Fully Threaded Attachment

By way of example, FIG. 4 shows another detachable coupling implementation between the suction eye adapter coupling member 18 and the corresponding suction eye adapter coupling member 22, e.g., using a fully threaded attachment generally indicated as 26. In FIG. 4, the removable integrated wear ring impeller skirt (aka the suction eye adapter) is retained to the main body 12 of the impeller 10 using mating threads machined into the members or parts 18, 22.

In FIG. 4, the suction eye adapter coupling member 18 and the corresponding suction eye adapter coupling member 22 may include the mated threaded faces 18b, 22b configured to provide the fully threaded attachment 26 between the impeller main body 12 and the removable suction eye adapter 20.

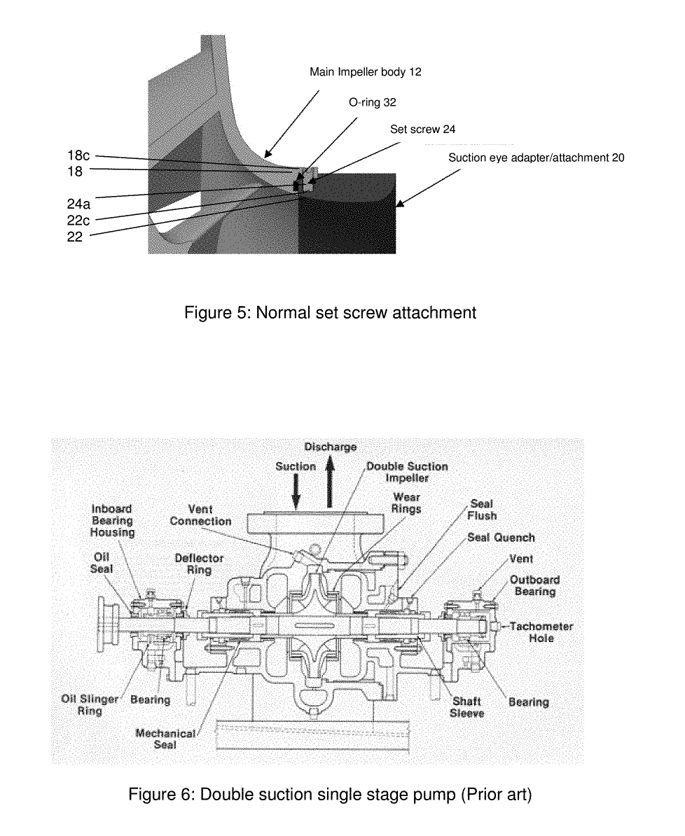

### FIG. 5: Normal Set Screw Attachment

By way of example, FIG. 5 shows still another detachable coupling implementation between the suction eye adapter coupling member 18 and the corresponding suction eye adapter coupling member 22, e.g., using a normal set screw attachment.

In FIG. 5, the double suction impeller 10 may include the set screw 24 having the threaded end 24a. The corresponding suction eye adapter coupling member 22 may include the threaded opening 22c configured to receive the threaded end 24a of the set screw 24. The suction eye adapter coupling member 18 may include a corresponding opening 18c configured to allow the set screw 24 to pass through and the threaded end 24a to be received by the threaded opening 22b of the corresponding suction eye adapter coupling member 22 to couple the removable suction eye adapter 20 to the impeller main body 12. In this embodiment, the set screw 24 may be configured normal to the flow of the pump medium.

### The Second Suction Eye 16

Consistent with that shown in FIG. 2, the double suction impeller 10 may include a second suction eye 14′. In this embodiment, the impeller main body 12 may include a second suction eye adapter coupling member 18′. The second suction eye 14′ may include a second removable suction eye adapter 20′ with a second corresponding suction eye adapter coupling member 22′ configured to couple detachably to the second suction eye adapter coupling member 18′ of the impeller main body 12, whereby the second removable suction eye adapter 20′ can be removed and replaced when wear and erosion occurs and can be a second separate cast and/or machined piece.

By way of example, the second corresponding suction eye adapter coupling member 22′ and the second suction eye adapter coupling member 18′ may be detachably coupled together using coupling implementations like that shown in FIGS. 3-5.

Consistent with that shown in FIG. 2, the removable suction eye adapter 20 and the second removable suction eye adapter 20′ may be configured as symmetrical and interchangeable removable suction eye adapters.

### The Gaskets and O-Rings

The double suction impeller 10 may include one or more gaskets 30 arranged between the suction eye adapter coupling member 18, 18′ and the corresponding suction eye adapter coupling member 22, 22′ and configured to prevent leakage. The gasket 30 may include a flat gasket, as shown in FIG. 3.

The double suction impeller may include one or more O-rings 32 arranged between the suction eye adapter coupling member 18, 18′ and the corresponding suction eye adapter coupling member 22, 22′ and configured to prevent leakage.

### The Detachable Coupling Implementations

The detachable coupling implementations are shown in FIGS. 3-5 by way of example. However, embodiments are envisioned, and the scope of the invention is intended to include, e.g., using other types or kinds of detachable coupling implementations for coupling components or parts together like elements 18, 18′ and 22, 22′ that are now known or later developed in the future within the spirit of the underlying invention. In other words, the scope of the invention is not intended to be limited to any particular type or kind of detachable coupling implementation for coupling components or parts together like elements 18, 18′ and 22, 22′.

### FIG. 6

Embodiments are envisioned, and the scope of the invention is intended to include, e.g., implementing the present invention by suitably adapting a double suction single stage pump like that shown in FIG. 6.

By way of example, the double suction single stage pump like that shown in FIG. 6 may be suitably adapted with a double suction impeller having an impeller main body and an impeller suction eye, e.g., like that shown in FIGS. 2-5, where the double suction impeller includes a suction eye adapter coupling member, e.g., like that shown in FIGS. 2-5, and where the impeller suction eye includes a removable suction eye adapter having a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece, e.g., like that shown in FIGS. 2-5.

One skilled in the art would appreciate and understand how to suitably adapted the double suction single stage pump like that shown in FIG. 6 so as to implement the present invention like that shown in FIGS. 2-5 without undue experimentation, e.g., consistent with that disclosed herein.

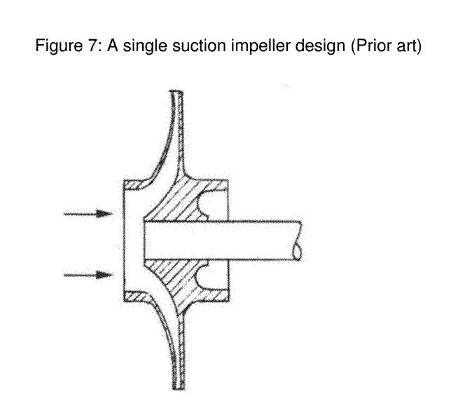

### FIG. 7

Embodiments are envisioned, and the scope of the invention is intended to include, e.g., implementing the present invention by suitably adapting a single suction impeller design like that shown in FIG. 7.

By way of example, the single suction impeller design like that shown in FIG. 7 may be suitably adapted with a suction impeller featuring an impeller main body and an impeller suction eye, e.g., like that shown in FIGS. 2-5, where the impeller main body includes a suction eye adapter coupling member, e.g., like that shown in FIGS. 2-5; and where the impeller suction eye includes a removable suction eye adapter having a corresponding suction eye adapter coupling member configured to couple detachably to the suction eye adapter coupling member of the impeller main body, whereby that the removable suction eye adapter can be removed and replaced when wear and erosion occurs and can be a separate cast and/or machined piece, e.g., like that shown in FIGS. 2-5.

One skilled in the art would appreciate and understand how to suitably adapted the single suction impeller design like that shown in FIG. 7 so as to implement the present invention like that shown in FIGS. 2-5 without undue experimentation, e.g., consistent with that disclosed herein.

### THE SCOPE OF THE INVENTION

The embodiments shown and described in detail herein are provided by way of example only; and the scope of the invention is not intended to be limited to the particular configurations, dimensionalities, and/or design details of these parts or elements included herein. In other words, one skilled in the art would appreciate that design changes to these embodiments may be made and such that the resulting embodiments would be different than the embodiments disclosed herein, but would still be within the overall spirit of the present invention.

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

What we claim is:

1. A double suction impeller comprising:
an impeller main body having a suction eye adapter coupling member; and
an impeller suction eye having a removable suction eye adapter with a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece.

2. A double suction impeller according to claim 1, wherein
the double suction impeller comprises a set screw having a threaded end;
the suction eye adapter coupling member includes a threaded opening configured to receive the threaded end of the set screw; and
the corresponding removable suction eye adapter includes a corresponding opening configured to allow the set screw to pass through and the threaded end to be received by the threaded opening of the suction eye adapter coupling member to couple the removable suction eye adapter to the impeller main body.

3. A double suction impeller according to claim 2, wherein the set screw is configured parallel to the flow of the pump medium.

4. A double suction impeller according to claim 1, wherein the suction eye adapter coupling member and the corresponding suction eye adapter coupling member have mated threaded faces configured to provide a fully threaded attachment between the impeller main body and the removable suction eye adapter.

5. A double suction impeller according to claim 1, wherein
the double suction impeller comprises a set screw having a threaded end;
the corresponding suction eye adapter coupling member includes a threaded opening configured to receive the threaded end of the set screw; and
the suction eye adapter coupling member includes a corresponding opening configured to allow the set screw to pass through and the threaded end to be received by the threaded opening of the corresponding suction eye adapter coupling member to couple the removable suction eye adapter to the impeller main body.

6. A double suction impeller according to claim 4, wherein the set screw is configured normal to the flow of the pump medium.

7. A double suction impeller according to claim 1, wherein
the impeller main body includes a second suction eye adapter coupling member; and
the double suction impeller comprises:
a second impeller suction eye having a second removable suction eye adapter with a second corresponding suction eye adapter coupling member configured to couple detachably to the second suction eye adapter coupling member of the impeller main body, whereby the second removable suction eye adapter can be removed and replaced when wear and erosion occurs and can be a second separate cast and/or machined piece.

8. A double suction impeller according to claim 7, wherein the double suction impeller comprises:
a second set screw having a corresponding threaded end;
the second suction eye adapter coupling member includes a second threaded opening configured to receive the corresponding threaded end of the second set screw; and
the second corresponding suction eye adapter coupling member includes a second corresponding opening configured to allow the second set screw to pass through and the corresponding threaded end to be received by the second threaded opening of the suction eye adapter coupling member to couple the second removable suction eye adapter to the impeller main body.

9. A double suction impeller according to claim 8, wherein the second set screw is configured parallel to the flow of the pump medium.

10. A double suction impeller according to claim 7, wherein the second suction eye adapter coupling member and the second corresponding suction eye adapter coupling member have second mated threaded faces configured to provide a second fully threaded attachment between the impeller main body and the second removable suction eye adapter.

11. A double suction impeller according to claim 8, wherein
the double suction impeller comprises a second set screw having a corresponding threaded end;
the second corresponding suction eye adapter coupling member includes a second threaded opening configured to receive the corresponding threaded end of the second set screw; and
the second suction eye adapter coupling member includes a second corresponding opening configured to allow the second set screw to pass through and the corresponding threaded end to be received by the second threaded opening of the second corresponding suction eye adapter coupling member to couple the second removable suction eye adapter to the impeller main body.

12. A double suction impeller according to claim 11, wherein the second set screw is configured normal to the flow of the pump medium.

13. A double suction impeller according to claim 1, wherein the double suction impeller comprises:
a gasket arranged between the suction eye adapter coupling member and the corresponding suction eye adapter coupling member and configured to prevent leakage.

14. A double suction impeller according to claim 8, wherein the double suction impeller comprises:
a second gasket arranged between the second suction eye adapter coupling member and the second corresponding suction eye adapter coupling member and configured to prevent leakage.

15. A double suction impeller according to claim 1, wherein the double suction impeller comprises:
an O-ring arranged between the suction eye adapter coupling member and the corresponding suction eye adapter coupling member and configured to prevent leakage.

16. A double suction impeller according to claim 8, wherein the double suction impeller comprises:
a second O-ring arranged between the second suction eye adapter coupling member and the second corresponding suction eye adapter coupling member and configured to prevent leakage.

17. A double suction impeller according to claim 8, wherein the removable suction eye adapter and the second removable suction eye adapter are configured as symmetrical and interchangeable removable suction eye adapters.

18. A pump comprising:
a double suction impeller having:
an impeller main body having a suction eye adapter coupling member; and
an impeller suction eye having a removable suction eye adapter with a corresponding suction eye adapter coupling member configured to couple detachably to the suction eye adapter coupling member of the impeller main body, whereby the removable suction eye adapter can be removed and replaced when wear and erosion occurs and can be a separate cast and/or machined piece.

19. A pump according to claim 18, wherein the pump is a centrifugal pump.

20. A suction impeller comprising:
an impeller main body having a suction eye adapter coupling member; and
an impeller suction eye having a removable suction eye adapter with a corresponding suction eye adapter coupling member configured to couple detachably to the suction eye adapter coupling member of the impeller main body, whereby that the removable suction eye adapter can be removed and replaced when wear and erosion occurs and can be a separate cast and/or machined piece.

21. A suction impeller according to claim 20, where the suction impeller is a double suction impeller.
